(19) United States
(12) Patent Application Publication
(10) Pub. No.: US 2026/0081481 A1
(43) Pub. Date: Mar. 19, 2026

(54) RECEIVER, CIRCUIT, AND WIRELESS POWER TRANSMISSION METHOD

(71) Applicant: AETERLINK CORP., Tokyo (JP)

(72) Inventors: Naoto KODATE, Tokyo (JP); Shingo HIKOSAKA, Tokyo (JP); Shingo TAKEUCHI, Tokyo (JP)

(21) Appl. No.: 19/396,630

(22) Filed: Nov. 21, 2025

Related U.S. Application Data
(63) Continuation-in-part of application No. PCT/JP2024/018082, filed on May 16, 2024.

(30) Foreign Application Priority Data
May 23, 2023 (JP) 2023-084638

(51) Int. Cl. H02J 50/80; H02J 50/20; H02J 50/40

(52) U.S. Cl. CPC H02J 50/80; H02J 50/40; H02J 50/20

(57) ABSTRACT

A receiver for wirelessly receiving transmitting power includes a control unit, a charging unit charged by the transmitting power, a sensor configured to measure a physical quantity, and a transmitter configured to transmit the physical quantity. The control unit includes a voltage acquisition module to detect a charging voltage of the charging unit, a threshold comparison module to compare the voltage with a threshold, and a power receiving state determination module to determine a power receiving state based on the comparison. The control unit includes a transmission control module to determine whether transmission is permitted based on the state. A transmission timing control module causes the transmitter to transmit at a predetermined interval. If transmission is not permitted, the timing is delayed by a predetermined time. If the timing is consecutively delayed a predetermined number of times, the transmission is performed after a next predetermined transmission interval.

### CROSS-REFERENCE TO RELATED APPLICATIONS

This is a continuation of International Application No. PCT/JP2024/018082 filed on May 16, 2024, which claims priority from Japanese Patent Application No. 2023-084638 filed on May 23, 2023, the entire content of which is incorporated herein by reference.

### TECHNICAL FIELD

The present disclosure relates to a receiver, a circuit, and a wireless power transmission method.

### BACKGROUND ART

A technology for saving power consumption of a receiver in a wireless power supply system is known. WO 2021/002007 A1 discloses a primary battery is provided in the receiver. In this case, replacement of the primary battery is unavoidable. In a configuration where a sensor device is provided in the receiver, it is preferable to deploy a large number of receivers. In such a case, a configuration in which the receiver is equipped with a primary battery is not practical.

Further, WO 2009/063923 A1 discloses a communication interval of wireless communication is changed according to a voltage value. In this case, there is a possibility of missing a timing to transmit a sensing result of the sensor device sequentially.

### SUMMARY OF INVENTION

Aspect of non-limiting embodiments of the present disclosure relates to provide a technology for saving power consumption of a receiver in a wireless power supply system.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided A receiver for wirelessly receiving transmitting power, the receiver including:
a control unit;
a charging unit to be electrically charged with the transmitting power;
a sensor configured to be driven by the transmitting power and to measure a predetermined physical quantity; and
a transmitter configured to transmit, to outside of the receiver, the physical quantity measured by the sensor,
in which the control unit includes:
   a voltage acquisition module configured to detect a power supply voltage which is a charging voltage of the charging unit;
   a threshold comparison module configured to compare the power supply voltage acquired by the voltage acquisition module with a threshold value prescribed for the power supply voltage;
   a power receiving state determination module configured to determine a power receiving state based on a comparison result by the threshold comparison module;
   a transmission control module configured to determine, based on a determination result by the power receiving state determination module, whether the transmitter is permitted to transmit; and
   a transmission timing control module configured to cause the transmitter to transmit the physical quantity to outside of the receiver at a predetermined transmission interval,
   in which, in case where the transmission control module determines that transmission is not permitted, the transmission timing control module delays a transmission timing by a predetermined time, and
   in which, in case where the transmission timing control module consecutively delayed the transmission timing a predetermined number of times, the transmission timing control module controls the transmission of the physical quantity to be performed after a next predetermined transmission interval.

### BRIEF DESCRIPTION OF DRAWINGS

Exemplary embodiment(s) of the present invention will be described in detail based on the following figures, wherein:

FIG. 1 is a diagram showing the overall configuration of a wireless power transmission system (WPT system) according to the first embodiment;

FIG. 2 is a block diagram showing a configuration example of the transmitter and the receiver shown in FIG. 1;

FIG. 3 is a diagram showing an outline of the circuit configuration of the receiver according to the first embodiment;

FIG. 4 is a diagram showing a functional configuration of the receiver according to the first embodiment;

FIG. 5 is a flowchart showing an example of a processing flow in the receiver according to the first embodiment;

FIG. 6 is a diagram showing a functional configuration of the receiver according to the second embodiment;

FIG. 7 is a diagram for explaining an example of a procedure for power reception state determination of the receiver in the WPT system according to the second embodiment;

FIG. 8 is a diagram showing a data structure of a determination table according to the second embodiment;

FIG. 9 is a diagram showing a data structure of a determination table according to the second embodiment;

FIG. 10 is a diagram showing a data structure of a determination table according to the second embodiment; and

FIG. 11 is a flowchart showing an example of a processing flow in the receiver according to the second embodiment.

### DESCRIPTION OF EMBODIMENTS

Embodiments of the present disclosure will be described below with reference to the drawings. Throughout the drawings for describing the embodiments, common components are denoted by the same reference numerals, and repeated descriptions are omitted. The following embodiments do not unduly limit the content of the present disclosure described in the claims. In addition, not all of the components shown in the embodiments are necessarily essential components of the present disclosure. Further, each drawing is a schematic diagram and is not necessarily strictly illustrated.

In the following description, “processor” refers to one or more processors. The at least one processor is typically a microprocessor such as a CPU (Central Processing Unit), but may be another type of processor such as a GPU (Graphics Processing Unit). The at least one processor may be a single core or a multi-core.

Further, the at least one processor may be a processor in a broad sense, such as a hardware circuit (for example, an FPGA (Field-Programmable Gate Array) or an ASIC (Application Specific Integrated Circuit)) that performs part or all of the processing.

In the following description, information from which an output can be obtained for an input may be described using expressions such as “xxx table,” but this information may be data of any structure, or may be a learning model such as a neural network that generates an output for an input. Therefore, “xxx table” can be referred to as “xxx information.”

In the following description, the configuration of each table is an example, and one table may be divided into two or more tables, or all or part of two or more tables may be one table.

In the following description, processing may be described with “program” as the subject, but since a program performs predetermined processing by being executed by a processor, appropriately using a storage unit and/or an interface unit, the subject of the processing may be the processor (or a device such as a controller having the processor).

The program may be installed on a device such as a computer, or may be, for example, in a program distribution server or a computer-readable (for example, non-transitory) recording medium. In the following description, two or more programs may be realized as one program, or one program may be realized as two or more programs.

In the following description, identification numbers are used as identification information for various objects, but types of identification information other than identification numbers (for example, identifiers including letters and symbols) may be employed.

In the following description, when elements of the same type are described without distinction, reference numerals (or common symbols among reference numerals) are used, and when elements of the same type are described with distinction, identification numbers (or reference numerals) of the elements may be used.

In the following description, control lines and information lines indicate those considered necessary for explanation, and do not necessarily indicate all control lines and information lines in the product. All configurations may be interconnected with each other.

### 0 System Overview

The WPT system according to the present disclosure includes a receiver that receives power transmitted from a transmitter based on a wireless power transmission method, supplies the power to a device such as a sensor, and transmits a physical quantity measured by this device to the transmitter or the like.

Although details will be described in the first embodiment, in the WPT system according to the present disclosure, a receiving antenna of the receiver receives microwave power (a substantially continuous continuous wave (CW) at 920 MHz), and the radio wave is converted into a DC voltage by a rectifier circuit functionally connected to the antenna. The DC voltage output from the rectifier circuit is supplied to a charging unit (mainly a capacitor) after the voltage is controlled by a power management unit. The energy storage element constituting the charging unit is not particularly limited, and may include capacitors, lithium-ion batteries, electric double-layer capacitors, ceramic capacitors, and the like. In the WPT system according to the present disclosure, the charging unit will be described as mainly including a capacitor. The voltage supplied from the power management unit is supplied to the charging unit when the voltage accumulated in the charging unit is less than a predetermined value. When the charging unit is charged to a predetermined voltage, the power supplied and output from the power management unit is supplied to the microcontroller and the device.

Here, since wireless power transmission is affected by the environment, it is difficult to stably supply a constant amount of power, and the amount of power supplied varies significantly over time. In addition, the amount of power supplied can similarly vary in solar cells and laser-based wireless power transmission. Even under such unstable power transmission conditions, it is necessary to continue stable power supply to the microcontroller of the receiver and further to sensors and the like included in the receiver.

Therefore, in the WPT system according to the present disclosure, the power reception state of the receiver is determined to judge whether or not the receiver can maintain the function of supplying power to the microcontroller or the like, and based on this judgment result, the timing of transmitting the physical quantity measured by the sensor to the transmitter or the like is adjusted (the transmission interval is optimized). As a result, the power consumption of the receiver can be saved, and the physical quantity measured by the sensor or the like can be reliably transmitted to the transmitter or the like.

In particular, in a wireless power transmission system, even if the power reception state of the receiver temporarily deteriorates, the reason is often temporary, such as a person passing between the transmitter and the receiver. Therefore, it can be expected that the power reception state of the receiver will recover after a certain period of time. From this, by adopting a method of temporarily extending the time interval for transmitting the physical quantity measured by the sensor to the transmitter or the like, the work of transmitting the physical quantity can be stably performed thereafter.

It goes without saying that the specific configuration of the WPT system according to the present disclosure is not limited to the above.

### 1. First Embodiment

### <1.1 Overall System Configuration>

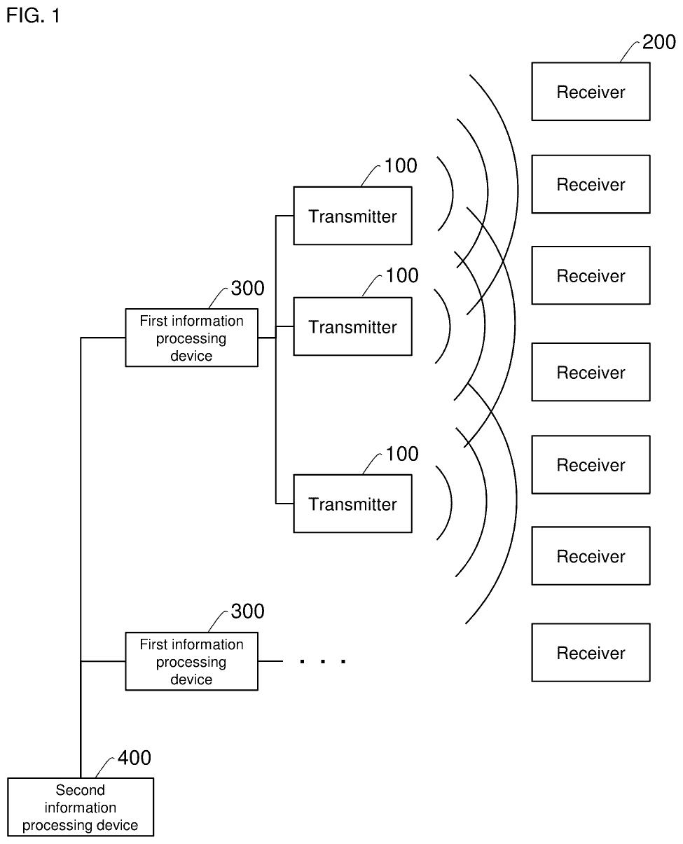

FIG. 1 is a diagram showing the overall configuration of a WPT system 1 according to the first embodiment.

The WPT system 1 shown in FIG. 1 includes, for example, a transmitter 100, a receiver 200, a first information processing device 300, and a second information processing device 400. The WPT system 1 shown in FIG. 1 is used, for example, in a building, a factory, or the like.

In this specification, the transmitter 100 is a (power) transmitter 100 in the sense of wirelessly transmitting power, and similarly, the receiver 200 is a (power) receiver 200 in the sense of wirelessly receiving power. As will be described later, the receiver 200 may, for example, transmit information regarding the state of the receiver 200 or information regarding measurement results by a sensor to the transmitter 100 as a data signal, and the transmitter 100 may receive such a data signal. In this case, the transmitter 100 functions as a receiver that receives data signals, and the receiver 200 functions as a transmitter that transmits data signals.

Although FIG. 1 shows an example in which the WPT system 1 includes three transmitters 100, the number of transmitters 100 included in the WPT system 1 is not limited to three. The number of transmitters 100 included in the WPT system 1 may be two or less, or may be four or more.

Although FIG. 1 shows an example in which the WPT system 1 includes seven receivers 200, the number of receivers 200 included in the WPT system 1 is not limited to seven. The number of receivers 200 included in the WPT system 1 may be six or less, or may be eight or more.

Although FIG. 1 shows an example in which the WPT system 1 includes two first information processing devices 300, the number of first information processing devices 300 included in the WPT system 1 is not limited to two. The number of first information processing devices 300 included in the WPT system 1 may be one, or may be three or more.

The transmitter 100 transmits, for example, a power transmission signal or a data signal to the receiver 200. The transmitter 100 transmits, for example, a power transmission signal to the receiver 200 using radio waves in the 920 MHz band. The transmitter 100 transmits, for example, a data signal to the receiver 200 using radio waves in the 2.4 GHz band. The transmitter 100 may transmit the data signal using radio waves in the 920 MHz band.

The power transmission signal transmitted from the transmitter 100 may be, as an example, a continuous wave (CW) having predetermined power. Further, the frequency band of the power transmission signal is, for example, the 920 MHz band in consideration of the distance between the transmitter 100 and the receiver 200. If the frequency band is higher than the exemplified frequency band, there is a possibility that the receiver 200 cannot be supplied with predetermined power for operation unless the distance between the transmitter 100 and the receiver 200 is shortened, so an appropriate frequency band can be determined by considering a practical range (for example, that the distance between the transmitter 100 and the receiver 200 is several meters).

At this time, depending on the laws of the country where the WPT system 1 is installed, there may be a restriction to intermittently transmit a power transmission signal having predetermined power. As an example, when the power transmission signal from the transmitter 100 falls under the provisions of a radio station stipulated in the Radio Act of Japan (regardless of whether or not a license is required), it may be necessary to provide a certain rest period for the power transmission signal based on the Radio Act. In this case, when considered on a certain time axis, the power transmission signal cannot be said to be a continuous wave. However, it is important to provide a rest period, and since this rest period may be very short, the power transmission signal transmitted from the transmitter 100 can be regarded as a substantially continuous continuous wave.

The transmitter 100 may, for example, supply power to one receiver 200 or may supply power to a plurality of receivers 200. The transmitter 100 may, for example, transmit a data signal to one receiver 200 or may transmit data signals to a plurality of receivers 200. The transmitter 100 may, for example, transmit the same data signal as another transmitter 100 or may transmit a data signal different from another transmitter 100. The transmitter 100 may, for example, transmit a predetermined command signal as a data signal to the receiver 200, or may transmit a preset signal as a data signal to the receiver 200.

The transmitter 100 receives, for example, a data signal transmitted from the receiver 200. The transmitter 100 may, for example, receive a data signal transmitted from one receiver 200 or may receive data signals transmitted from a plurality of receivers 200. The transmitter 100 transmits the data signal transmitted from the receiver 200 to the first information processing device 300. The transmitter 100 transmits information regarding the state of the transmitter 100 to the first information processing device 300.

The receiver 200 receives, for example, a power transmission signal or a data signal transmitted from the transmitter 100. When the receiver 200 has, for example, a charging unit, the receiver 200 converts the power transmission signal transmitted from the transmitter 100 into power and stores the converted power in the charging unit. When the receiver 200 has, for example, a predetermined sensor, the receiver 200 converts the power transmission signal transmitted from the transmitter 100 into power and drives the sensor with the converted power.

The receiver 200 transmits, for example, information regarding the state of the receiver 200 or information regarding measurement results by a sensor to the transmitter 100 as a data signal.

The first information processing device 300 is an information processing device that monitors the operations of the transmitter 100 and the receiver 200 accommodated in the WPT system 1. For example, the first information processing device 300 judges whether or not the transmitter 100 or the receiver 200 is in a preset state, based on information regarding the states of the transmitter 100 and the receiver 200 transmitted from the transmitter 100. When it is judged that the preset state has been reached, the first information processing device 300 transmits predetermined information to the second information processing device 400.

Further, the first information processing device 300 accumulates information about the transmitter 100 and the receiver 200 accommodated in the WPT system 1. For example, the first information processing device 300 stores information regarding the states of the transmitter 100 and the receiver 200 transmitted from the transmitter 100 in a storage unit provided in the first information processing device 300.

Further, the first information processing device 300 controls the operation of the transmitter 100 accommodated in the WPT system 1.

The second information processing device 400 is an information processing device operated by an administrator of the WPT system 1. When the second information processing device 400 receives from the first information processing device 300 a notification that the transmitter 100, the receiver 200, or both accommodated in the WPT system 1 are in a predetermined state, the second information processing device 400 presents to the user that the transmitter 100, the receiver 200, or both are in the predetermined state.

Further, the second information processing device 400 analyzes information regarding the states of the transmitter 100 and the receiver 200 accumulated in the first information processing device 300, and presents predetermined information to the user. The predetermined information is, for example, as follows:
Information regarding the arrangement of the transmitter 100
Information regarding the arrangement of the receiver 200
Information regarding power consumption
Information regarding power intensity

### <1.2 Configuration of Transmitter and Receiver>

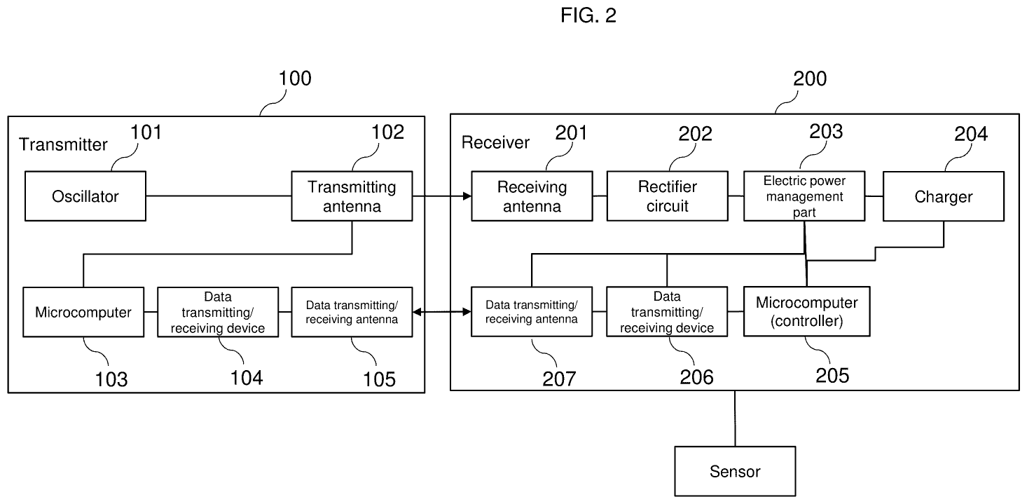

FIG. 2 is a block diagram showing a configuration example of the transmitter 100 and the receiver 200 shown in FIG. 1. As shown in FIG. 2, the transmitter 100 and the receiver 200 are, for example, separated from each other at a predetermined interval. For example, the transmitter 100 and the receiver 200 are installed separated by a distance of about several meters. Specifically, for example, the transmitter 100 is fixedly installed at a high location indoors, for example, on a ceiling or at a predetermined high position provided on a wall. The receiver 200 is installed on a predetermined device indoors or placed in the vicinity of a device requiring power transmission. Further, the receiver 200 may be carried by a user. The transmitter 100 transmits a power transmission signal to the receiver 200 using radio waves of a predetermined frequency, for example, the 920 MHz band. The receiver 200 converts the power transmission signal transmitted from the transmitter 100 into power, and charges the converted power or supplies the converted power to a predetermined device.

The transmitter 100 includes, for example, an oscillator 101, a transmitting antenna 102, a microcontroller (controller) 103, a data transceiver 104, and a data transceiver antenna 105. The oscillator 101, the microcontroller 103, and the data transceiver 104 may be mounted, for example, on a PCB (printed circuit board).

The oscillator 101 oscillates a signal in a predetermined frequency band, for example, the 920 MHz band. The oscillated signal may be amplified and unnecessary frequency components may be removed as necessary.

The transmitting antenna 102 is formed, for example, to be capable of efficiently transmitting radio waves in the 920 MHz band. The transmitting antenna 102 radiates the signal oscillated by the oscillator 101 as a power transmission signal.

The microcontroller 103 controls the operation of the transmitter 100. The microcontroller 103 is realized, for example, by a semiconductor element equipped with an ARM processor. The microcontroller 103 controls, for example, transmission of radio waves by the transmitting antenna 102.

For example, in the WPT system 1 used in a factory, it is desirable that the receiver 200 supply power of a predetermined value or more. Therefore, the microcontroller 103 controls transmission of radio waves by the transmitting antenna 102 based on a feedback signal transmitted from the receiver 200. The feedback signal relates to, for example, a voltage value at a predetermined portion within the receiver 200. Based on the feedback signal, the electric field strength of the receiver 200 can be estimated. When the transmitting antenna 102 has, for example, a plurality of antenna elements, the microcontroller 103 controls the transmitting antenna 102 to transmit, for example, a power transmission signal from an optimal antenna element. For example, the microcontroller 103 adjusts the polarization direction of the power transmission signal by switching the antenna element to be driven. Further, the microcontroller 103 adjusts the directivity direction of the power transmission signal by adjusting the driving timing of the antenna element.

Further, in the WPT system 1 used indoors in a building or the like, the microcontroller 103 controls transmission of radio waves by the transmitting antenna 102 based on a feedback signal transmitted from the receiver 200. When the transmitting antenna 102 is, for example, a single antenna element, the microcontroller 103 optimizes, for example, the transmission output from the transmitting antenna 102.

The data transceiver 104 performs processing such as digital-to-analog conversion and modulating analog data. Further, the data transceiver 104 performs processing such as demodulating signals extracted from data signals received by the data transceiver antenna 105 and digitizing the demodulated analog data. The data transceiver 104, for example, extracts a feedback signal from a data signal received by the data transceiver antenna 105, converts it into digital data, and transmits it to the microcontroller 103.

The data transceiver antenna 105 is formed, for example, to be capable of efficiently transmitting and receiving radio waves in the 2.4 GHz band. The data transceiver antenna 105 radiates a data signal supplied from the data transceiver 104. Further, the data transceiver antenna 105 receives a data signal transmitted from the receiver 200.

The receiver 200 includes, for example, a receiving antenna 201, a rectifier circuit 202, a power management unit 203, a charging unit 204, a microcontroller 205, a data transceiver 206, and a data transceiver antenna 207. The rectifier circuit 202, the power management unit 203, the charging unit 204, the microcontroller 205, and the data transceiver 206 may be mounted, for example, on a PCB or FPC (flexible printed circuit).

The receiving antenna 201 is formed, for example, to be capable of efficiently receiving radio waves in the 920 MHz band. The receiving antenna 201 receives a power transmission signal radiated from the transmitting antenna 102.

The rectifier circuit 202 rectifies the radio wave received as a power transmission signal and converts it into a DC voltage.

The power management unit 203 manages the DC voltage. For example, the power management unit 203 controls a charging voltage based on the DC voltage. The power management unit 203 charges the charging unit 204 by controlling the charging voltage. Further, the power management unit 203 supplies, for example, the DC voltage to connected members when power of a predetermined capacity or more is stored in the charging unit 204.

Further, the power management unit 203 causes the power stored in the charging unit 204 to be discharged in response to control from the microcontroller 205.

The charging unit 204 stores power in response to an instruction from the power management unit 203. Further, the charging unit 204 discharges the stored power in response to an instruction from the power management unit 203.

The microcontroller 205 (hereinafter sometimes referred to as MCU (Microcontroller) as appropriate) controls the operation of the receiver 200. The microcontroller 205 is driven by the DC voltage supplied from the power management unit 203 or the power stored in the charging unit 204. The microcontroller 205 controls the power management unit 203 to cause the power stored in the charging unit 204 to be discharged.

Various sensors can be connected to the receiver 200, for example. For example, a thermal sensor, a temperature sensor, an optical sensor, a humidity sensor, a vibration sensor, or the like is connected to the receiver 200. The sensor connected to the receiver 200 is driven, for example, by the DC voltage supplied from the power management unit 203 or the power discharged from the charging unit 204. The microcontroller 205 continuously or intermittently monitors the voltage value at a predetermined portion of the receiver 200, the status of the sensor connected to the receiver 200, information (physical quantity) detected by the sensor, and the like. The microcontroller 205 transmits the voltage value at a predetermined portion of the receiver 200, the status of the sensor connected to the receiver 200, information detected by the sensor, and the like as digital data to the data transceiver 206.

The data transceiver 206 performs processing such as analogizing digital data supplied from the microcontroller 205 and modulating analog data. Further, the data transceiver 206 performs processing such as demodulating analog data and digitizing the demodulated analog data. The data transceiver 206 is driven, for example, by the DC voltage supplied from the power management unit 203 or the power discharged from the charging unit 204.

The data transceiver antenna 207 is formed, for example, to be capable of efficiently transmitting and receiving radio waves in the 2.4 GHz band. The data transceiver antenna 207 radiates a data signal supplied from the data transceiver 206. Further, the data transceiver antenna 207 receives a data signal transmitted from the transmitter 100. For example, the data transceiver antenna 207 is driven, for example, by the DC voltage supplied from the power management unit 203 or the power discharged from the charging unit 204.

The transmission format of the data signal transmitted (radiated) from the data transceiver antenna 207 is arbitrary. In particular, since the data signal radiated from the data transceiver antenna 207 is a radio wave in the 2.4 GHz band, it may be a signal compliant with Bluetooth (registered trademark) or IEEE 802.11x (that is, so-called wireless LAN) format. In this case, it is preferable that the data transceiver 104 of the transmitter 100 also has a function capable of analyzing a data signal in a format matching the format of the data signal transmitted from the receiver 200. Alternatively, the first information processing device 300 may also have such a function.

### <1.3 Circuit Configuration of Receiver>

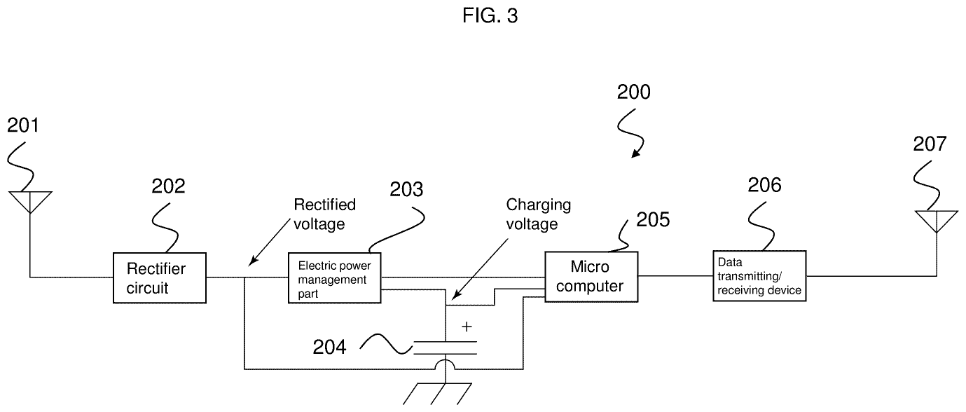

FIG. 3 is a diagram showing an outline of the circuit configuration of the receiver 200 shown in FIG. 2. In the following description, detailed descriptions of the components of the receiver 200 described with reference to FIG. 2 are omitted. Further, only the main parts of the components of the receiver 200 shown in FIG. 2 are illustrated.

In FIG. 3, the rectified voltage, which is the voltage at the subsequent stage (that is, the output side of the rectifier circuit 202) of the rectifier circuit 202, and the power supply voltage, which is the charging voltage of the charging unit 204, are input to the microcontroller 205, converted into digital values by an A/D converter unit included in the microcontroller 205, and used for power reception state determination to be described later.

### <1.4 Functional Configuration of Microcontroller 205>

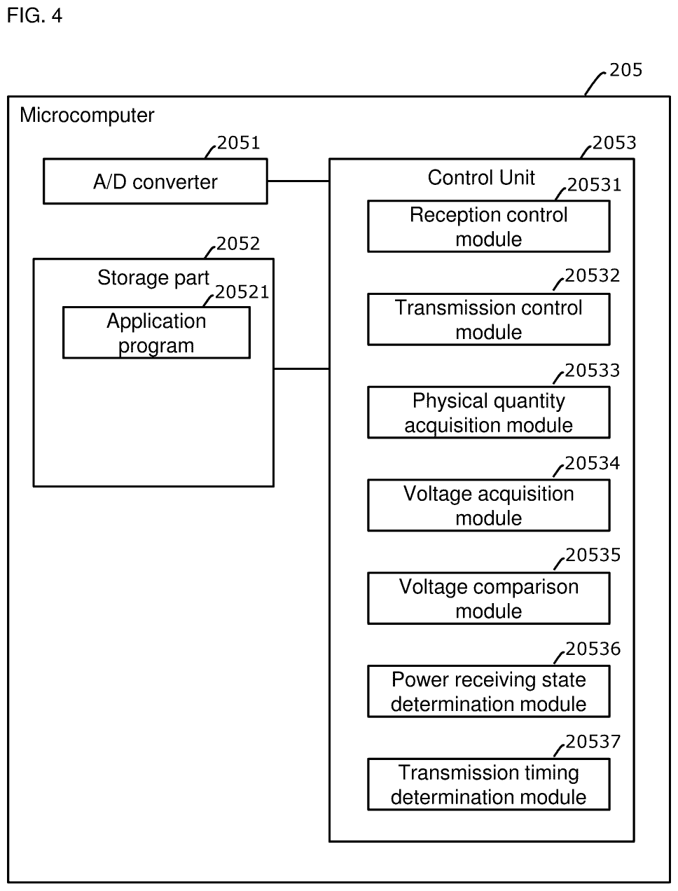

FIG. 4 is a diagram showing an example of the functional configuration of the microcontroller 205. As shown in FIG. 4, the microcontroller 205 exhibits functions as an A/D converter unit 2051, a storage unit 2052, and a control unit 2053.

The A/D converter unit 2051 performs processing to convert an analog signal input to the microcontroller 205 into a digital value. The A/D converter unit 2051 may include an A/D converter as a circuit. The digital value that is the output of the A/D converter unit 2051 is input to the control unit 2053. The A/D converter unit 2051 of the present embodiment converts the rectified voltage and the power supply voltage, which are analog signals, into digital values, respectively, and outputs the digital values as conversion results to the control unit 2053.

The control unit 2053 is realized by the microcontroller 205 reading an application program 20521 stored in its own storage unit 2052 and executing instructions included in the application program 20521. By operating according to the application program 20521, the control unit 2053 exhibits functions shown as a reception control module 20531, a transmission control module 20532, a physical quantity acquisition module 20533, a voltage acquisition module 20534, a voltage comparison module 20535, a power reception state determination module 20536, and a transmission timing determination module 20537.

The reception control module 20531 controls processing in which the microcontroller 205 receives signals from external devices such as the transmitter 100 according to a communication protocol.

The transmission control module 20532 controls processing in which the microcontroller 205 transmits signals to external devices such as the transmitter 100 according to a communication protocol. In particular, the transmission control module 20532 of the present embodiment periodically transmits the physical quantity measured by the sensor to the transmitter 100 or the like as a data signal at constant time intervals. However, the transmission timing of the data signal, including whether or not to actually transmit the physical quantity to the transmitter 100 or the like, follows the timing determined by the transmission timing determination module 20537.

The physical quantity acquisition module 20533 acquires the physical quantity measured by the sensor and temporarily stores the acquired physical quantity in the storage unit 2052. Preferably, the physical quantity acquisition module 20533 temporarily stores the acquired physical quantity in the storage unit 2052 together with a timestamp of when it was acquired.

The number of times and timing of acquisition of physical quantities by the physical quantity acquisition module 20533 are arbitrary and are not particularly limited. In the receiver 200 of the present embodiment, as an example, the physical quantity acquisition module 20533 acquires physical quantities periodically, that is, at predetermined time intervals. The timing at which the physical quantity acquisition module 20533 acquires a physical quantity and the timing at which the transmission control module 20532 transmits the acquired physical quantity to the transmitter 100 or the like do not have to coincide, and the transmission control module 20532 does not necessarily transmit a data signal to the transmitter 100 or the like in conjunction with the physical quantity acquisition module 20533 acquiring a physical quantity. As an example, the transmission control module 20532 may collectively transmit physical quantities acquired multiple times by the physical quantity acquisition module 20533 as a data signal to the transmitter 100 or the like.

The voltage acquisition module 20534 acquires, for example, values obtained by converting the power supply voltage and the rectified voltage into digital values from the A/D converter unit 2051. In the present embodiment, the voltage acquisition module 20534 only needs to acquire at least the power supply voltage from the A/D converter unit 2051, and acquisition of the rectified voltage is optional. The timing and interval of acquisition of the power supply voltage by the voltage acquisition module 20534 are arbitrary, and may be acquired periodically, or may be acquired in accordance with the timing at which the transmission control module 20532 transmits the physical quantity measured by the sensor as a data signal to the transmitter 100 or the like. The term “in accordance with” here includes the meaning of being in accordance with the timing at which the data signal can be transmitted to the transmitter 100 or the like, considering the time required for the comparison operation with the threshold by the voltage comparison module 20535 described later and the determination operation by the power reception state determination module 20536.

The reason for aligning the acquisition timing of the power supply voltage by the voltage acquisition module 20534 with the timing at which the transmission control module 20532 transmits the physical quantity measured by the sensor as a data signal to the transmitter 100 or the like is that, since the microcontroller 205 consumes a large amount of power by transmitting the data signal, by determining the power reception state of the receiver 200 when the microcontroller 205 consumes power, the power reception state of the receiver 200 can be appropriately determined. At times other than data signal transmission, the rectified voltage and power supply voltage rise due to wireless power transmission from the transmitter 100, and the power reception state is considered to progress in a favorable direction. In addition, from the viewpoint of appropriately determining the timing of transmitting the physical quantity measured by the sensor to the transmitter 100 or the like by the transmission timing determination module 20537 described later, it is preferable to adjust the transmission timing of the data signal immediately before the transmission timing of the data signal.

The voltage acquisition module 20534 that has acquired the digital value of the power supply voltage stores the acquired voltage value in the storage unit 2052 at least temporarily. Further, the voltage acquisition module 20534 may store the acquired voltage value in the storage unit 2052 in association with the voltage value acquisition time measured by a timer (not shown). The storage period in the storage unit 2052 is arbitrary, and may be continuously stored after the receiver 200 is installed and the microcontroller 205 starts operating, may be erased when power transmission from the transmitter 100 is interrupted and the receiver 200 temporarily becomes inoperable, or may be erased when the power reception state determination by the power reception state determination module 20536 is completed.

The voltage comparison module 20535 compares the digital value of the power supply voltage acquired by the voltage acquisition module 20534 with a predetermined threshold of the power supply voltage, respectively. Then, the voltage comparison module 20535 sends to the power reception state determination module 20536 the result of comparison between the digital value of the power supply voltage and the threshold, for example, the magnitude relationship between the value of the power supply voltage and the threshold.

The power reception state determination module 20536 determines the power reception state of the receiver 200 based on the comparison result between the digital value of the power supply voltage and the threshold received from the voltage comparison module 20535, and sends the determination result to the transmission timing determination module 20537. There is no particular limitation on the variations of the power reception state of the receiver 200 determined by the power reception state determination module 20536, and as an example, if the digital value of the power supply voltage exceeds the threshold, the power reception state of the receiver 200 is favorable, that is, a determination that the microcontroller 205 operates stably, operating power to the sensor can be stably supplied, and further, data signal transmission from the receiver 200 can be stably performed. On the other hand, if the digital value of the power supply voltage is equal to or less than the threshold, the power reception state of the receiver 200 is unstable, that is, a determination that there is no guarantee that the microcontroller 205 can continue to operate, there is no guarantee that supply of operating power to the sensor can continue, and further, there is no guarantee that data signal transmission from the receiver 200 can continue. What kind of power reception state determination is performed is determined by the relationship between the guaranteed operating voltage of the microcontroller 205 and the threshold, and the like.

Here, a configuration in which the receiver 200 acquires only the digital value of the power supply voltage, sends this digital value to the transmitter 100, and the transmitter 100 and/or the first information processing device 300 and the second information processing device 400 determine the power reception state of the receiver 200 is also conceivable. There is no intention to exclude such a configuration in the WPT system 1 according to the present disclosure.

On the other hand, there is an advantage that by the receiver 200 determining its own power reception state, detailed and flexible operation control based on the determination result can be performed. In addition, as shown in FIG. 1, when the transmitter 100 is configured to receive data from a plurality of receivers 200, if the transmitter 100 or the like determines the power reception state of each receiver 200, the computational load on the transmitter 100 or the like becomes large. For the above reasons, in the WPT system 1 according to the present disclosure, the power reception state determination is mainly performed by the receiver 200.

The specific value of the threshold that forms the basis of the comparison operation of the voltage comparison module 20535 may be appropriately determined according to the circuit configuration of the receiver 200. In particular, since the power supply voltage can also be considered as the voltage of the operating power supply of the microcontroller 205, it can also be determined as a voltage value at which the microcontroller 205 can operate. In the voltage comparison module 20535 of the present embodiment, as an example, the threshold is set to 2.2 V. The threshold is stored in advance in the storage unit 2052 of the microcontroller 205. The threshold can also be updated based on data transmission from the transmitter 100.

Then, the transmission timing determination module 20537 determines the timing of transmitting the physical quantity measured by the sensor as a data signal to the transmitter 100 or the like based on the determination result of the power reception state of the receiver 200 received from the power reception state determination module 20536. “Determining the transmission timing” here includes determining whether or not to transmit a data signal at the present time.

There is no particular limitation on the method by which the transmission timing determination module 20537 determines the transmission timing of the data signal. As an example, there is a method of determining to transmit the data signal to the transmitter 100 or the like immediately (that is, without delay) when the power reception state determination module 20536 determines that the power reception state of the receiver 200 is favorable. In particular, when the acquisition timing of the power supply voltage by the voltage acquisition module 20534 is aligned with the timing at which the transmission control module 20532 transmits the physical quantity measured by the sensor as a data signal to the transmitter 100 or the like, the transmission timing determination module 20537 makes a determination not to delay the transmission timing of the data signal. On the other hand, when the power reception state determination module 20536 determines that the power reception state of the receiver 200 is unstable, the transmission timing determination module 20537 makes a determination to delay the transmission timing of the data signal by a predetermined time. This is because, if delayed by a predetermined time, there is a high possibility that the power reception state of the receiver 200 will recover, in other words, become favorable, and by delaying by a predetermined time, the possibility of being able to transmit the data signal with little difference from the normal data signal transmission timing increases.

The delay of a predetermined time referred to here is preferably a delay sufficiently smaller than the normal transmission interval of data signals. As an example, if the transmission interval of data signals is set to 1 minute, the delay is about 10 seconds.

The series of processes from acquisition of the digital value of the power supply voltage by the voltage acquisition module 20534 to timing determination by the transmission timing determination module 20537 is preferably repeated a predetermined number of times when the transmission timing determination module 20537 determines to delay the transmission timing of the data signal by a predetermined time. That is, since the determination result of the power reception state of the receiver 200 by the power reception state determination module 20536 is expected to change in a short time, in other words, since it is expected that the power reception state determination module 20536 will determine that the power reception state of the receiver 200 is stable a short time after determining that the power reception state of the receiver 200 is unstable, by repeating the series of processes from acquisition of the digital value of the power supply voltage by the voltage acquisition module 20534 to timing determination by the transmission timing determination module 20537 a predetermined number of times, it can be expected to obtain a determination that the power reception state of the receiver 200 is favorable at an early stage, and as a result, the possibility of being able to transmit the data signal to the transmitter 100 or the like without significant delay can be increased.

Furthermore, when a determination that the power reception state of the receiver 200 is favorable is not reached even after repeating the series of processes from acquisition of the digital value of the power supply voltage by the voltage acquisition module 20534 to timing determination by the transmission timing determination module 20537 a predetermined number of times, the transmission timing determination module 20537 may execute the series of processes from acquisition of the digital value of the power supply voltage by the voltage acquisition module 20534 to timing determination by the transmission timing determination module 20537 when the timing to transmit the data signal next arrives, and determine again whether or not to transmit the data signal.

### <1.5 Operation Example>

An example of the operation of the microcontroller 205 will be described below.

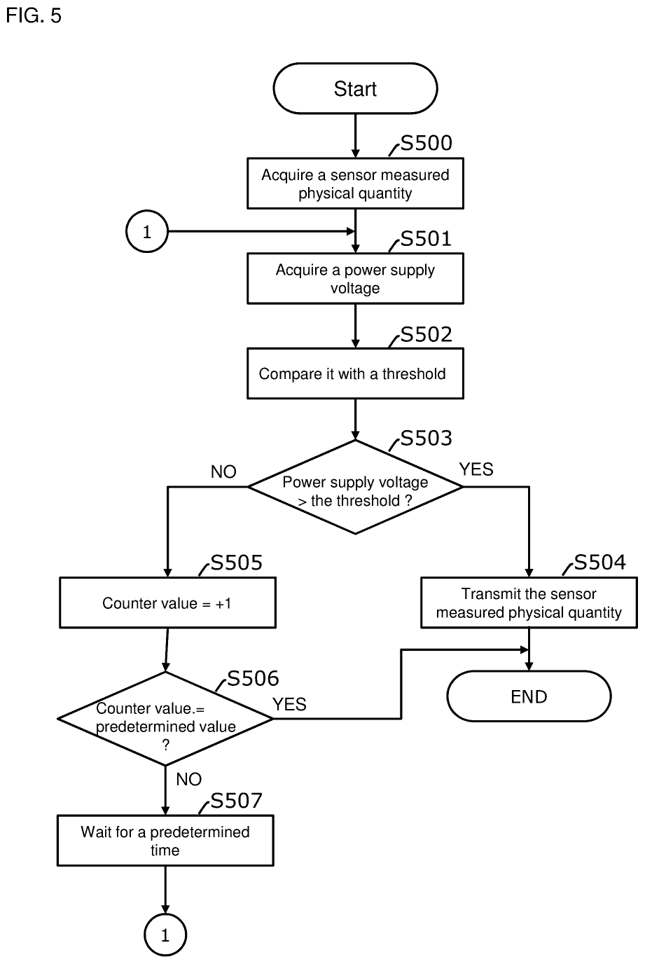

FIG. 5 is a flowchart showing an example of the main operation of the microcontroller 205. The operation shown in the flowchart of FIG. 5 is preferably started in accordance with the timing of acquiring the digital value of the power supply voltage by the voltage acquisition module 20534. Further, the operation order of each step shown in the flowchart of FIG. 5 is not limited to that shown, and the operation order can be changed as appropriate. In the receiver 200 of the present embodiment, the flowchart shown in FIG. 5 is executed periodically at predetermined time intervals.

In step S500, the control unit 2053 acquires the physical quantity measured by the sensor. Specifically, for example, the control unit 2053 acquires the physical quantity measured by the sensor by the physical quantity acquisition module 20533. The control unit 2053 temporarily stores the acquired physical quantity in the storage unit 2052.

In step S501, the control unit 2053 acquires the digital value of the power supply voltage from the A/D converter unit 2051. Specifically, for example, the control unit 2053 acquires the digital value of the power supply voltage from the A/D converter unit 2051 by the voltage acquisition module 20534. The control unit 2053 stores the acquired digital value of the power supply voltage in the storage unit 2052 at least temporarily.

Next, in step S502, the control unit 2053 compares the digital value of the power supply voltage acquired in step S501 with a predetermined threshold. Specifically, for example, the control unit 2053 compares the digital value of the power supply voltage acquired in step S501 with a predetermined threshold by the voltage comparison module 20535.

Thereafter, in step S503, if the control unit 2053 determines that the digital value of the power supply voltage exceeds the threshold as a result of the comparison operation in step S502 (YES in step S503), the control unit 2053 proceeds to step S504, and if it determines that the digital value of the power supply voltage is equal to or less than the threshold (NO in step S503), the control unit 2053 proceeds to step S505. Specifically, for example, if the control unit 2053 determines by the power reception state determination module 20536 that the digital value of the power supply voltage exceeds the threshold as a result of the comparison operation in step S502 (YES in step S503), the control unit 2053 proceeds to step S504, and if it determines that the digital value of the power supply voltage is equal to or less than the threshold (NO in step S503), the control unit 2053 proceeds to step S505.

The affirmative determination in step S503 corresponds to a determination that the power reception state of the receiver 200 is stable, and the negative determination in step S503 corresponds to a determination that the power reception state of the receiver 200 is unstable.

In step S504, the control unit 2053 transmits the physical quantity acquired by the physical quantity acquisition module 20533 as a data signal to the transmitter 100 or the like. Specifically, for example, the control unit 2053 transmits the physical quantity acquired by the physical quantity acquisition module 20533 as a data signal to the transmitter 100 or the like by the transmission timing determination module 20537 and the transmission control module 20532. In this case, the data signal is transmitted to the transmitter 100 or the like at predetermined time intervals. Thereafter, the operation of the flowchart shown in FIG. 5 ends.

On the other hand, in step S505, the control unit 2053 increments the counter value by one. Specifically, for example, the control unit 2053 increments the counter value by one by the transmission timing determination module 20537. This counter is reset each time the operation of the flowchart shown in FIG. 5 starts.

Next, in step S506, the control unit 2053 determines whether or not the counter value incremented in step S505 has reached a predetermined value, and if it determines that the predetermined value has been reached (YES in step S506), the control unit 2053 ends the program, and if it determines that the predetermined value has not yet been reached (NO in step S506), the control unit 2053 proceeds to step S507. Specifically, for example, the control unit 2053 determines by the transmission timing determination module 20537 whether or not the counter value incremented in step S505 has reached a predetermined value, and if it determines that the predetermined value has been reached (YES in step S506), the control unit 2053 ends the program, and if it determines that the predetermined value has not yet been reached (NO in step S506), the control unit 2053 proceeds to step S507.

The fact that the counter value has reached the predetermined value means that the determination in step S503 has been negated a predetermined number of times. This means that although the power reception state of the receiver 200 was determined a predetermined number of times, it was determined that the power reception state was unstable for the predetermined number of consecutive times, and corresponds to the transmission timing determination module 20537 determining not to transmit the data signal until the next timing when the flowchart shown in FIG. 5 is executed, without performing the operation of the data signal at the timing shown in FIG. 5.

Here, the predetermined number of times in step S506 can be set arbitrarily, but as an example, it is 5 times.

In step S507, the control unit 2053 causes the operation of the flowchart shown in FIG. 5 to wait for a predetermined time. Specifically, for example, the control unit 2053 causes the operation of the flowchart shown in FIG. 5 to wait for a predetermined time by the transmission timing determination module 20537. Thereafter, the process returns to step S501, and the operations from step S501 onward are repeated.

Causing the operation of the flowchart to wait for a predetermined time in step S507 is to determine the power reception state of the receiver 200 after the predetermined time, and thereafter, if it is determined that the reception state of the receiver 200 is favorable, it corresponds to the transmission timing determination module 20537 having delayed the transmission of the data signal by the predetermined time.

### <1.6 Effects of One Embodiment>

As described in detail above, according to the WPT

system 1 of the present embodiment, it is possible to provide a technology capable of saving power consumption of the receiver 200 in the receiver 200 that is wirelessly powered.

As described above, when the transmission timing determination module 20537 determines that the power reception state of the receiver 200 is stable, it transmits a data signal to the transmitter 100 or the like based on a predetermined time interval. Further, when the power reception state of the receiver 200 is unstable, the transmission timing determination module 20537 delays the transmission timing of the data signal by a predetermined time, and thereafter causes the power reception state determination module 20536 to determine the power reception state of the receiver 200 again. Furthermore, when a determination that the power reception state of the receiver 200 is stable is not reached even after the power reception state determination module 20536 performs determination of the power reception state of the receiver 200 a predetermined number of times, transmission of the data signal at the predetermined time interval is not performed, and transmission of the data signal at the next timing is attempted. As a result, the data signal can be transmitted to the transmitter 100 or the like when it is determined that the power reception state of the receiver 200 is stable, and by avoiding the operation of transmitting the data signal to the transmitter 100 or the like when the power reception state is unstable, that is, when the power supply voltage is equal to or less than the threshold (that is, thinning out transmission of the data signal), the data signal can be transmitted only when there is sufficient power in the charging unit 204. Therefore, power consumption of the receiver 200 (of the charging unit 204) can be saved.

### <1.7 Modified Example>

In the WPT system 1 of the present embodiment described above, the microcontroller 205 of the receiver 200 has the A/D converter unit 2051. However, in the WPT system 1 of the present embodiment, the configuration for acquiring the digital value of the power supply voltage is not limited to this. As an example, a comparator that compares voltage values with a threshold may be arranged in the stage before input to the microcontroller 205, and the output value of the comparator may be input to the microcontroller 205. In this case, since the output value of the comparator can be a digital value, it is not necessary to provide the A/D converter unit 2051. Further, a reset IC may be used instead of the comparator.

In this way, a configuration in which the comparison operation between the power supply voltage and the threshold does not depend on internal processing of the microcontroller 205 is sufficiently possible. Such a configuration is the same when the microcontroller 205 of the receiver 200 acquires the digital value of the rectified voltage and the comparison operation with the threshold for the rectified voltage does not depend on internal processing of the microcontroller 205.

Further, in the WPT system 1 of the present embodiment described above, a comparison between the power supply voltage and a threshold was performed, but the threshold may have a plurality of thresholds. That is, a plurality of thresholds having different voltage values as thresholds may be provided, and detailed power reception state determination may be performed depending on which threshold among the thresholds the power supply voltage is equal to or less than, or below.

### 2. Second Embodiment

In the WPT system 1 of the first embodiment described above, a comparison between the voltage value of the acquired power supply voltage and a threshold was performed. In the WPT system 1 according to the second embodiment, more detailed power reception state determination is performed for the receiver 200 based on the time change of the comparison between the rectified voltage and a first threshold determined for this rectified voltage, and the comparison between the power supply voltage and a second threshold determined for this power supply voltage.

The characteristic points of the WPT system 1 according to the second embodiment are summarized below.
A plurality of thresholds are provided for at least the second threshold, or more precisely, it is determined whether at least the second threshold is between any of the plurality of thresholds (that is, a range).
The state of time change of at least one of the power supply voltage and the rectified voltage is classified, and this state of time change is used for power reception state determination

Then, in the WPT system 1 of the present embodiment, the power reception state of the receiver 200 is determined based on which range at least one of the power supply voltage and the rectified voltage is in, and the state of time change of at least one of the power supply voltage and the rectified voltage.

Hereinafter, an example will be described in which a plurality of thresholds are provided as the second threshold for the power supply voltage to detect which range the power supply voltage is in, the state of time change of the power supply voltage is determined, and the power reception state of the receiver 200 is determined based on the range to which the power supply voltage belongs and the state of time change of the power supply voltage. However, it goes without saying that a similar range and state of time change may be detected for the rectified voltage, and the power reception state of the receiver 200 may be determined in the same manner as in the first embodiment described above.

Here, in the WPT system 1 of the present embodiment, the plurality of thresholds for the second threshold are stored in the storage unit 2052, and the determination of which range the power supply voltage is in and the determination of the state of time change of the power supply voltage are performed by the voltage comparison module 20535 of the control unit 2053.

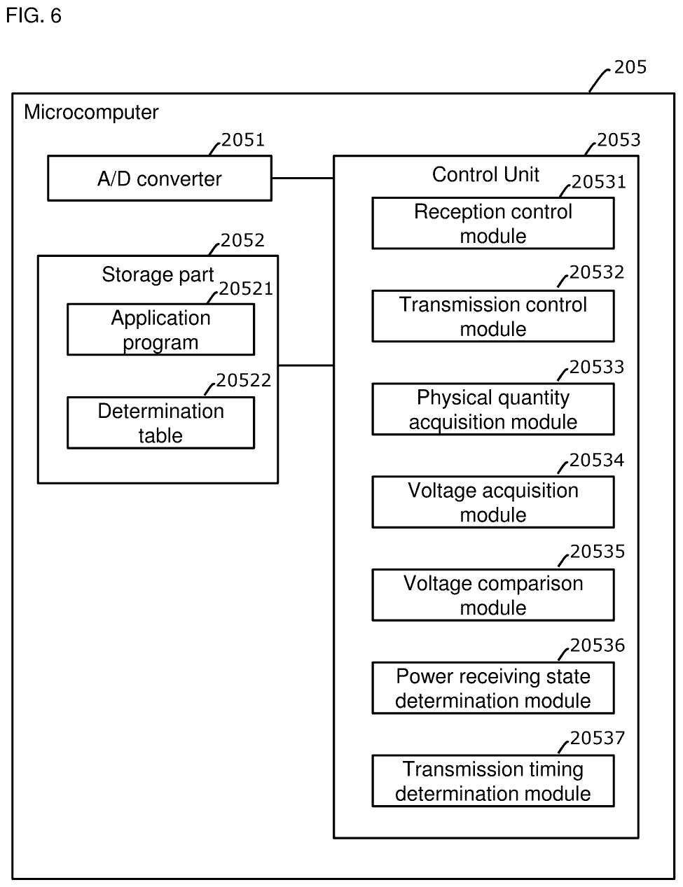

FIG. 6 is a diagram showing an example of the functional configuration of the microcontroller 205.

The storage unit 2052 has, for example, a determination table 20522 and the like.

The determination table 20522 is a table describing how to determine the power reception state of the receiver 200 for the condition of whether or not each of the power supply voltage and the rectified voltage is equal to or less than a threshold. The determination table 20522 may be stored in the storage unit 2052 of the microcontroller 205 in a pre-created form at the time of manufacturing the receiver 200 or the microcontroller 205, or may be transmitted from at least one of the transmitter 100, the first information processing device 300, and the second information processing device 400 after installation of the receiver 200.

The first threshold and the second threshold, which are used by the voltage comparison module 20535 and serve as the basis for power reception state determination, may be different values. For example, the power management unit 203 may convert the voltage value of the output voltage of the rectifier circuit 202 and supply it to the charging unit 204 and the microcontroller 205. Therefore, the appropriate value of the rectified voltage, which is the output value from the rectifier circuit 202, and the appropriate value of the power supply voltage related to the output value from the power management unit 203 may differ. The specific values of the first threshold and the second threshold may be appropriately determined according to the circuit configuration of the receiver 200. However, if the standard value in circuit design is, for example, 5 V as the output voltage value from the rectifier circuit 202, the first threshold should be a value slightly lower than 5 V, and similarly, if the output voltage value from the power management unit 203 is 3.3 V, the second threshold should be set to a value slightly lower than 3.3 V. Further, since the power supply voltage is the charging voltage to the charging unit 204 and can also be considered as the voltage of the operating power supply of the microcontroller 205, the second threshold can also be determined as a voltage value that enables charging of the charging unit 204 and/or a voltage value at which the microcontroller 205 can operate.

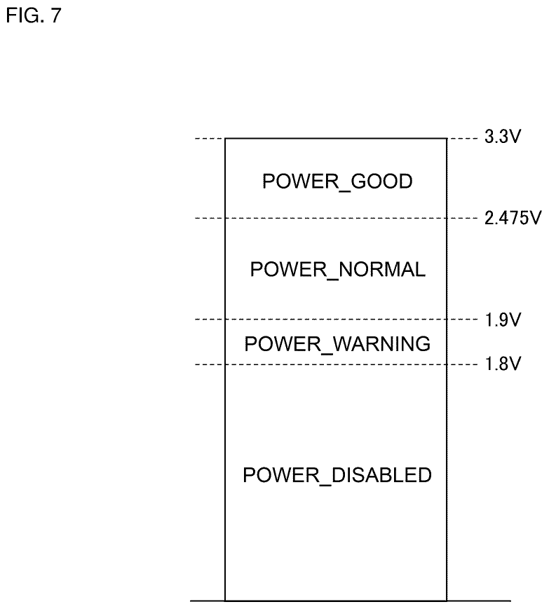

FIG. 7 is a diagram showing a plurality of thresholds constituting the second threshold used in the WPT system 1 of the present embodiment, and ranges of power supply voltage defined by these thresholds. The voltage comparison module 20535 compares the power supply voltage with the second threshold based on the ranges shown in FIG. 7.

In the WPT system 1 of the present embodiment, the second threshold has four thresholds (3.3 V, 2.475 V, 1.9 V, 1.8 V), and the ranges between these thresholds are defined as POWER_GOOD, POWER_NORMAL, POWER_WARNING, and POWER_DISABLED, respectively, in descending order of voltage value. These ranges indicate:
POWER_GOOD . . . The power supply voltage is good (the charging voltage to the charging unit 204 and the operating voltage of the microcontroller 205 can be sufficiently secured)
POWER_NORMAL . . . The power supply voltage is normal (no problem as the charging voltage to the charging unit 204 and the operating voltage of the microcontroller 205)
POWER_WARNING . . . The power supply voltage is in a caution state (there is a possibility that the charging voltage to the charging unit 204 and the operating voltage of the microcontroller 205 cannot be secured)
POWER_DISABLED . . . The power supply voltage is critical (the charging voltage to the charging unit 204 and the operating voltage of the microcontroller 205 cannot be secured)

When the power supply voltage is POWER_DISABLED, since the microcontroller 205 cannot operate in the first place (it is below the operable voltage), it is difficult for the voltage comparison module 20535 to determine that the power supply voltage is POWER_DISABLED. Therefore, a determination that the power supply voltage is POWER_DISABLED can be excluded from the algorithm for power reception state determination in the power reception state determination module 20536.

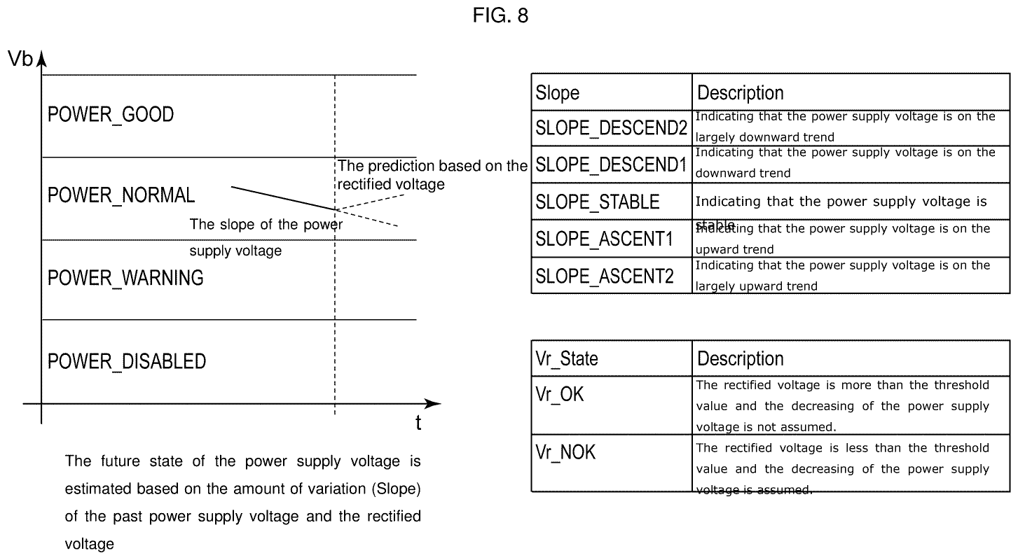

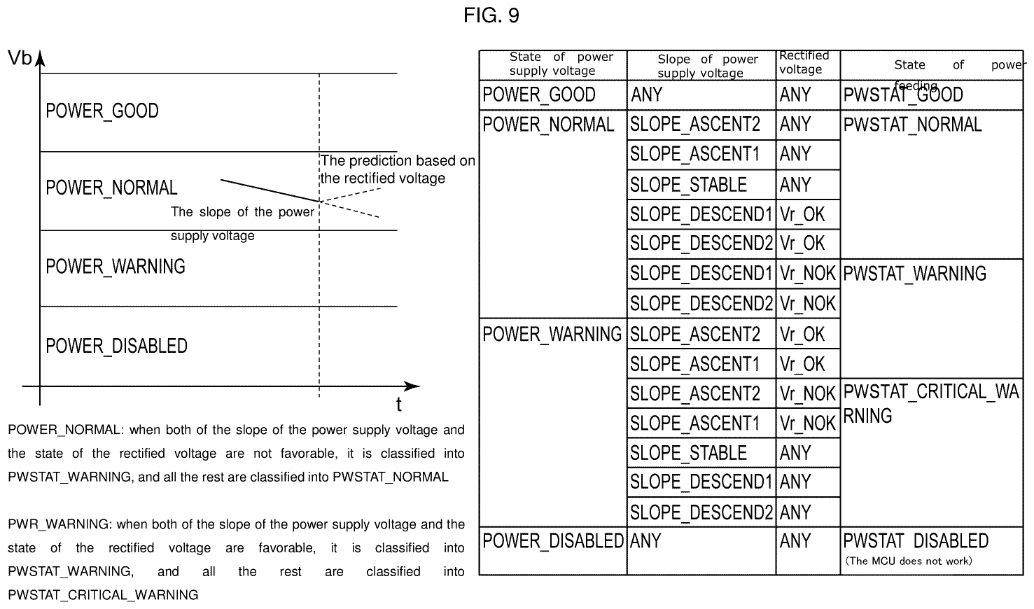

FIG. 8 is a diagram showing an example of a determination table 20522 that defines the state of time change of the power supply voltage and the state of the rectified voltage. The power reception state determination module 20536 determines the power reception state of the receiver 200 based on the determination table 20522 shown in FIG. 8 and FIG. 9 described later.

For the power supply voltage, the state is defined by whether the power supply voltage is in an increasing trend or a decreasing trend. However, in the WPT system 1 of the present embodiment, two stages of definition are further provided for the increasing trend/decreasing trend of the power supply voltage. That is, a threshold is also provided for the slope of increase/decrease of the power supply voltage, and the definition of the state is changed depending on whether there is an increase/decrease of the power supply voltage exceeding this threshold. The threshold relating to the slope of increase of the power supply voltage can be set arbitrarily.

For the rectified voltage, a determination is made as to whether it exceeds or falls below the first threshold. By determining the power reception state of the receiver 200 based on both the increasing/decreasing trend of the power supply voltage and the magnitude relationship between the rectified voltage and the first threshold, the state of the power supply voltage in the future can be estimated. As an example, if the power supply voltage is in a decreasing trend but the rectified voltage exceeds the first threshold, it can be determined that the power supply voltage will recover thereafter and the current decreasing trend will not continue (a decrease in the power supply voltage is not expected in the future).

FIG. 9 is a diagram showing an example of a determination table 20522 for the power reception state of the receiver 200 in the WPT system 1 of the present embodiment. Even when the state of the power supply voltage is POWER_NORMAL, the final determination of the power reception state (power transmission state) is made different depending on the increasing/decreasing trend of the power supply voltage and the relationship between the rectified voltage and the threshold. Similarly, even when the state of the power supply voltage is POWER_WARNING, the final determination of the power reception state (power transmission state) is made different depending on the increasing/decreasing trend of the power supply voltage and the relationship between the rectified voltage and the threshold.

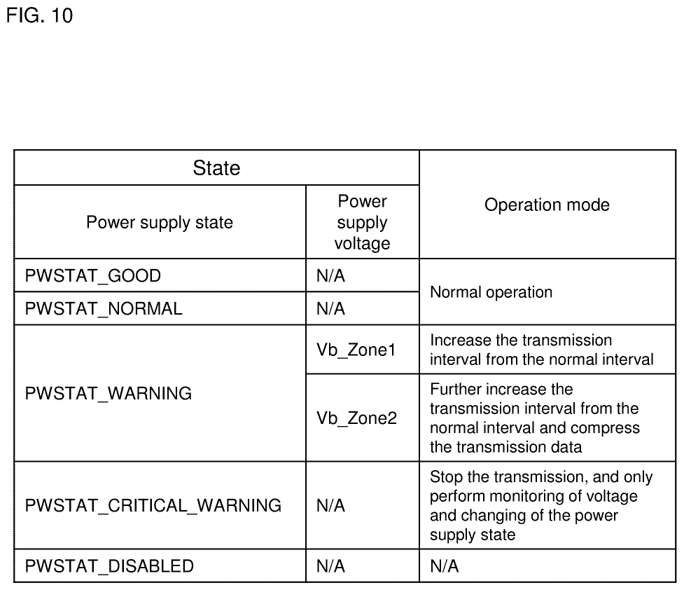

FIG. 10 is a diagram for explaining a determination table for an operation mode, which is a transmission mode of data signals of the receiver 200 in the WPT system 1 of the present embodiment. The determination table shown in FIG. 10 is stored in the storage unit 2052, and the transmission timing determination module 20537 determines an operation mode for the data signal based on the determination table shown in FIG. 10, and determines the transmission timing of the data signal according to the determined operation mode.

As shown in FIG. 10, in the receiver 200 of the present embodiment, the operation mode is determined based on the power transmission state of the receiver 200 and the voltage value of the power supply voltage at that time.

In the determination table shown in FIG. 10, if the power transmission state is PWSTAT_GOOD or PWSTAT_NORMAL, the transmission timing determination module 20537 determines it as a normal operation mode regardless of the digital value of the power supply voltage (N/A).

Further, if the power transmission state is PWSTAT_WARNING, the transmission timing determination module 20537 determines the operation mode based on the digital value of the power supply voltage. Here, both Vb_Zone1 and Vb_Zone2 indicate ranges of the power supply voltage, and the lower limit value of Vb_Zone1 and the upper limit value of Vb_Zone2 are assumed to be the same. If the power transmission state is PWSTAT_WARNING, the power reception state of the receiver 200 is currently unstable or is likely to become unstable in the future, so the operation mode is determined based on the range of the power supply voltage. If the power supply voltage is within the range of Vb_Zone1, it is considered that there is a possibility that a determination will subsequently be made that the power reception state of the receiver 200 is stable, and the data signal is transmitted by increasing (that is, extending) the transmission interval of the data signal from the normal transmission interval. On the other hand, when the power supply voltage is in the range of Vb_Zone2, it is considered that there is a low possibility that a determination will be made that the power reception state of the receiver 200 is stable, and the transmission interval of the data signal is further extended, and in addition, the data signal is compressed to the minimum.

Furthermore, if the power transmission state is PWSTAT_CRITICAL_WARNING, the digital value of the power supply voltage is irrelevant (N/A), and it is considered that sufficient power cannot be secured to transmit the data signal, so transmission of the data signal from the receiver 200 is stopped, and the microcontroller 205 performs only monitoring of the power supply voltage and determination operation of the power transmission state.

If the power transmission state is PWSTAT_DISABLED, since operating power for the microcontroller 205 cannot be secured in the first place, determination of the operation mode itself is not made (cannot be made).

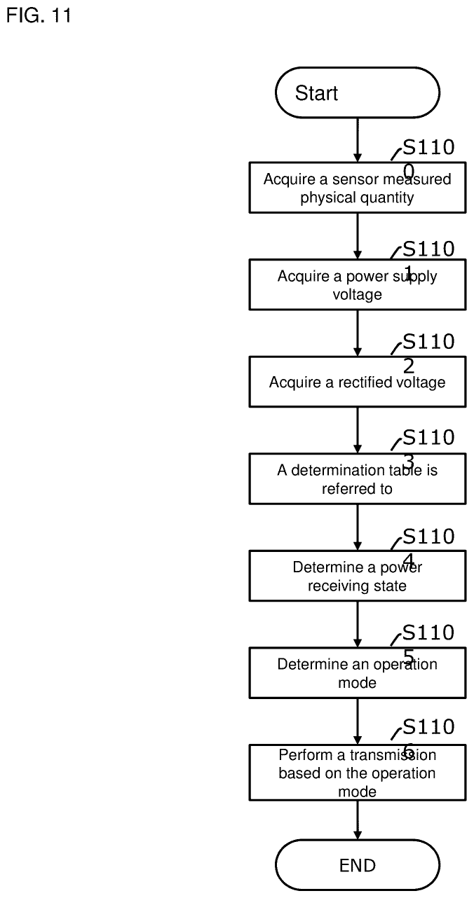

FIG. 11 is a flowchart showing an example of the main operation of the microcontroller 205. The operation shown in the flowchart of FIG. 11 is preferably started in accordance with the timing of acquiring the digital values of the rectified voltage and the power supply voltage by the voltage acquisition module 20534. Further, the operation order of each step shown in the flowchart of FIG. 11 is not limited to that shown, and the operation order can be changed as appropriate. As an example, the order of acquisition of the power supply voltage and the rectified voltage shown in steps S1101 and S1102 is not limited, and they may be acquired asynchronously or may be acquired simultaneously. In the receiver 200 of the present embodiment, the flowchart shown in FIG. 11 is executed periodically at predetermined time intervals.

In step S1100, the control unit 2053 acquires the physical quantity measured by the sensor. Specifically, for example, the control unit 2053 acquires the physical quantity measured by the sensor by the physical quantity acquisition module 20533. The control unit 2053 temporarily stores the acquired physical quantity in the storage unit 2052.

In steps S1101 and step S1102, the control unit 2053 acquires the digital values of the power supply voltage and the rectified voltage from the A/D converter unit 2051. Specifically, for example, the control unit 2053 acquires the digital values of the power supply voltage and the rectified voltage from the A/D converter unit 2051 by the voltage acquisition module 20534. The control unit 2053 stores the acquired digital values of the power supply voltage and the rectified voltage in the storage unit 2052 at least temporarily.

Next, in step S1103, the control unit 2053 compares the voltage values of the power supply voltage and the rectified voltage acquired in steps S1101 and S1102 with the determination table 20522. Specifically, for example, the control unit 2053 compares the voltage values of the power supply voltage and the rectified voltage acquired in steps S1101 and S1102 with the determination table 20522 by the voltage comparison module 20535. The comparison operation with the determination table 20522 in step S1103 does not need to be performed immediately after steps S1101 and S1102, and may be performed independently of the voltage value acquisition timing by steps S1101 and S1102. Hereinafter, the operations from step S1104 onward also do not need to be performed immediately after steps S1101 and S1102, and may be performed independently of the voltage value acquisition timing by steps S1101 and S1102.

Next, in step S1104, the control unit 2053 determines the power reception state of the receiver 200 based on the comparison result in step S1103. Specifically, for example, the control unit 2053 determines the power reception state of the receiver 200 by the power reception state determination module 20536 based on the comparison result in step S1103.

Then, in step S1105, the control unit 2053 determines an operation mode for the data signal based on the determination result in step S1104. Specifically, for example, the control unit 2053 determines an operation mode for the data signal by the transmission timing determination module 20537 based on the determination result in step S1104. The transmission timing determination module 20537 temporarily stores the operation mode determined in step S1105 in the storage unit 2052. Thereafter, in step S1106, the control unit 2053 transmits the data signal to the transmitter 100 or the like according to the operation mode determined in step S1105. Specifically, for example, the control unit 2053 transmits the data signal to the transmitter 100 or the like by the transmission control module 20532 and the transmission timing determination module 20537 according to the operation mode determined in step S1105.

Therefore, according to the WPT system 1 of the present embodiment, since the power reception state of the receiver 200 is determined including the state of time change of the power supply voltage and the relationship between the rectified voltage and the threshold, the power reception state of the receiver 200 can be determined more finely, the power reception state of the receiver 200 in the future can be determined, and the accuracy of power reception state determination can be further improved. As a result, similarly to the first embodiment, and preferably more than the first embodiment, it is possible to provide a technology capable of further saving power consumption of the receiver 200 in the receiver 200 that is wirelessly powered.

The above-described embodiments describe the configuration in detail for the purpose of explaining the present disclosure in an easy-to-understand manner, and are not necessarily limited to those having all the described configurations. Further, it is possible to add, delete, or replace a part of the configuration of each embodiment with another configuration.

As an example, in each of the above-described embodiments, the power reception state determination of the receiver was mainly performed by the receiver 200, but the receiver 200 may transmit the values (digital values) of the rectified voltage and the power supply voltage as signals to the transmitter 100 and the first information processing device 300, and the transmitter 100 and the first information processing device 300 may determine the power reception state of the receiver 200 based on the values of the rectified voltage and the like transmitted from the receiver 200. That is, in FIGS. 4 and 6, a configuration is also possible in which the power reception state determination module 20536 is provided in at least one of the transmitter 100 or the first information processing device 300, and the transmission control module 20532 transmits the rectified voltage and the power supply voltage acquired by the voltage acquisition module 20534 to at least one of the transmitter 100 or the first information processing device 300.

Further, in each of the above-described embodiments, application to a so-called WPT system 1 in which transmission power consisting of an AC signal is wirelessly transmitted from the transmitter 100 to the receiver 200 has been described, but application to a system that provides power to the receiver 200 by other methods is also naturally possible. Since such systems are known, detailed description is omitted, but examples include a system that transmits power generated by solar power generation to the receiver 200 regardless of whether wired or wireless, and further, a system that transmits power by laser light to the receiver 200 regardless of whether wired or wireless. In addition, a configuration in which vibration or sound is given to the receiver 200 and the receiver 200 converts the power of vibration or the like into electric power is also applicable. In addition, the present disclosure is naturally applicable to systems using known contactless power supply technology other than wirelessly receiving transmission power consisting of an AC signal, for example, a system using contactless power supply technology by a magnetic field coupling method.

Further, each of the above configurations, functions, processing units, processing means, and the like may be realized in hardware by designing a part or all of them, for example, with an integrated circuit. Further, the present invention can also be realized by program codes of software that realizes the functions of the embodiments. In this case, a storage medium on which the program code is recorded is provided to a computer, and a processor included in the computer reads the program code stored in the storage medium. In this case, the program code itself read from the storage medium realizes the functions of the above-described embodiments, and the program code itself and the storage medium storing it constitute the present invention. As a storage medium for supplying such program code, for example, a flexible disk, CD-ROM, DVD-ROM, hard disk, SSD, optical disk, magneto-optical disk, CD-R, magnetic tape, non-volatile memory card, ROM, or the like is used.

Further, the program code that realizes the functions described in the present embodiments can be implemented in a wide range of programming or script languages such as, for example, assembler, C/C++, Perl, Shell, PHP, Java (registered trademark), and the like.

Furthermore, by distributing the program code of software that realizes the functions of the embodiments via a network, it may be stored in storage means such as a hard disk or memory of a computer or in a storage medium such as a CD-RW or CD-R, and a processor included in the computer may read and execute the program code stored in the storage means or the storage medium.

The matters described in each of the above embodiments are described below as notes.

### Notes

### (Note 1)

A receiver for wirelessly receiving transmitting power, the receiver including: a control unit; a charging unit to be electrically charged with the transmitting power; a sensor configured to be driven by the transmitting power and to measure a predetermined physical quantity; and a transmitter configured to transmit, to outside of the receiver, the physical quantity measured by the sensor, in which the control unit includes: a voltage acquisition module configured to detect a power supply voltage which is a charging voltage of the charging unit; a threshold comparison module configured to compare the power supply voltage acquired by the voltage acquisition module with a threshold value prescribed for the power supply voltage; a power receiving state determination module configured to determine a power receiving state based on a comparison result by the threshold comparison module; a transmission control module configured to determine, based on a determination result by the power receiving state determination module, whether the transmitter is permitted to transmit; and a transmission timing control module configured to cause the transmitter to transmit the physical quantity to outside of the receiver at a predetermined transmission interval, wherein, in case where the transmission control module determines that transmission is not permitted, the transmission timing control module delays a transmission timing by a predetermined time, and wherein, in case where the transmission timing control module consecutively delayed the transmission timing a predetermined number of times, the transmission timing control module controls the transmission of the physical quantity to be performed after a next predetermined transmission interval.

### (Note 2)

The receiver according to Note 1, in which the transmission timing control module operates the voltage acquisition module, the threshold comparison module, the power receiving state determination module, and the transmission control module in synchronization with a timing of transmitting the physical quantity.

### (Note 3)

The receiver according to Note 1, further including: a rectifier configured to rectify the transmitting power; and an electric power management part configured to manage a rectified voltage from the rectifier, in which the voltage acquisition module acquires changes of the rectified voltage over time and/or changes of the power supply voltage of the charging unit over time, and in which the power receiving state determination module determines the power receiving state based on the changes over time.

### (Note 4)

The receiver according to Note 3, in which the transmission timing control module changes a transmission interval of the physical quantity based on a determination result by the power receiving state determination module.

### (Note 5)

The receiver according to Note 3, wherein the threshold comparison module compares the rectified voltage with a first threshold value, and/or compares the power supply voltage with a second threshold value, and in which the power receiving state determination module determines the power receiving state based on these comparison results.

### (Note 6)

An electronic circuit for operating a receiver that wirelessly receives transmitting power composed of AC signals, the electronic circuit including: a control unit; a charging unit to be electrically charged with the transmitting power; a sensor configured to be driven by the transmitting power and to measure a predetermined physical quantity; and a transmitter configured to transmit, to outside of the receiver, the physical quantity measured by the sensor, in which the control unit includes a processor and a memory storing instructions that, when executed by the processor, cause the control unit to: detect a power supply voltage which is a charging voltage of the charging unit; compare the detected power supply voltage with a threshold value prescribed for the power supply voltage; determine a power receiving state based on a result of the comparison; determine, based on a result of the determination of the power receiving state, whether the transmitter is permitted to transmit; cause the transmitter to transmit the physical quantity at a predetermined transmission interval; delay, in case where it is determined that transmission is not permitted, a transmission timing by a predetermined time; and control, in case where the transmission timing is consecutively delayed a predetermined number of times, the transmission of the physical quantity to be performed after a next predetermined interval.

### (Note 7)

A wireless power transmission method executed by a receiver for wirelessly receiving transmitting power, the receiver including: a control unit; a charging unit to be electrically charged with the transmitting power; a sensor configured to be driven by the transmitting power and to measure a predetermined physical quantity; and a transmitter configured to transmit, to outside of the receiver, the physical quantity measured by the sensor, in which the control unit configured to execute: a voltage acquisition step of detecting a power supply voltage which is a charging voltage of the charging unit; a threshold comparison step of comparing the power supply voltage detected in the voltage acquisition step with a threshold value prescribed for the power supply voltage; a power receiving state determination step of determining a power receiving state of the receiver based on a comparison result in the threshold comparison step; a transmission control step of determining, based on a determination result in the power receiving state determination step, whether transmission by the transmitter is permitted; and a transmission timing control step of causing the transmitter to transmit the physical quantity to outside of the receiver at a predetermined transmission interval, in which, in case where the transmission control step determines that transmission is not permitted, the transmission timing control step delays a transmission timing by a predetermined time, and in which, in case where the transmission timing control step consecutively delays the transmission timing a predetermined number of times, the transmission timing control step controls the transmission of the physical quantity to be performed after a next predetermined transmission interval.

What is claimed is:

1. A receiver for wirelessly receiving transmitting power, the receiver comprising:
a control unit;
a charging unit to be electrically charged with the transmitting power;
a sensor configured to be driven by the transmitting power and to measure a predetermined physical quantity; and
a transmitter configured to transmit, to outside of the receiver, the physical quantity measured by the sensor,
wherein the control unit includes:
a voltage acquisition module configured to detect a power supply voltage which is a charging voltage of the charging unit;
a threshold comparison module configured to compare the power supply voltage acquired by the voltage acquisition module with a threshold value prescribed for the power supply voltage;
a power receiving state determination module configured to determine a power receiving state based on a comparison result by the threshold comparison module;
a transmission control module configured to determine, based on a determination result by the power receiving state determination module, whether the transmitter is permitted to transmit; and
a transmission timing control module configured to cause the transmitter to transmit the physical quantity to outside of the receiver at a predetermined transmission interval,
wherein, in case where the transmission control module determines that transmission is not permitted, the transmission timing control module delays a transmission timing by a predetermined time, and
wherein, in case where the transmission timing control module consecutively delayed the transmission timing a predetermined number of times, the transmission timing control module controls the transmission of the physical quantity to be performed after a next predetermined transmission interval.

2. The receiver according to claim 1, wherein the transmission timing control module operates the voltage acquisition module, the threshold comparison module, the power receiving state determination module, and the transmission control module in synchronization with a timing of transmitting the physical quantity.

3. The receiver according to claim 1, further comprising:
a rectifier configured to rectify the transmitting power; and
an electric power management part configured to manage a rectified voltage from the rectifier,
wherein the voltage acquisition module acquires changes of the rectified voltage over time and/or changes of the power supply voltage of the charging unit over time, and
wherein the power receiving state determination module determines the power receiving state based on the changes over time.

4. The receiver according to claim 3, wherein the transmission timing control module changes a transmission interval of the physical quantity based on a determination result by the power receiving state determination module.

5. The receiver according to claim 3, wherein the threshold comparison module compares the rectified voltage with a first threshold value, and/or compares the power supply voltage with a second threshold value, and
wherein the power receiving state determination module determines the power receiving state based on these comparison results.

6. An electronic circuit for operating a receiver that wirelessly receives transmitting power composed of AC signals, the electronic circuit comprising:
a control unit;
a charging unit to be electrically charged with the transmitting power;
a sensor configured to be driven by the transmitting power and to measure a predetermined physical quantity; and
a transmitter configured to transmit, to outside of the receiver, the physical quantity measured by the sensor,
wherein the control unit includes a processor and a memory storing instructions that, when executed by the processor, cause the control unit to:
detect a power supply voltage which is a charging voltage of the charging unit; compare the detected power supply voltage with a threshold value prescribed for the power supply voltage;
determine a power receiving state based on a result of the comparison;
determine, based on a result of the determination of the power receiving state, whether the transmitter is permitted to transmit;
cause the transmitter to transmit the physical quantity at a predetermined transmission interval;
delay, in case where it is determined that transmission is not permitted, a transmission timing by a predetermined time; and control, in case where the transmission timing is consecutively delayed a predetermined number of times, the transmission of the physical quantity to be performed after a next predetermined interval.

7. A wireless power transmission method executed by a receiver for wirelessly receiving transmitting power, the receiver comprising:
a control unit;
a charging unit to be electrically charged with the transmitting power;
a sensor configured to be driven by the transmitting power and to measure a predetermined physical quantity; and
a transmitter configured to transmit, to outside of the receiver, the physical quantity measured by the sensor,
wherein the control unit configured to execute:
a voltage acquisition step of detecting a power supply voltage which is a charging voltage of the charging unit;
a threshold comparison step of comparing the power supply voltage detected in the voltage acquisition step with a threshold value prescribed for the power supply voltage;
a power receiving state determination step of determining a power receiving state of the receiver based on a comparison result in the threshold comparison step;
a transmission control step of determining, based on a determination result in the power receiving state determination step, whether transmission by the transmitter is permitted; and
a transmission timing control step of causing the transmitter to transmit the physical quantity to outside of the receiver at a predetermined transmission interval, wherein, in case where the transmission control step determines that transmission is not permitted, the transmission timing control step delays a transmission timing by a predetermined time, and
wherein, in case where the transmission timing control step consecutively delays the transmission timing a predetermined number of times, the transmission timing control step controls the transmission of the physical quantity to be performed after a next predetermined transmission interval.
